(19) United States
(12) Patent Application Publication
(10) Pub. No.: US 2008/0307660 A1
(43) Pub. Date: Dec. 18, 2008

(54) Pivotally Actuated Pump Driven Liquid Dispensing Shaving Razor

(76) Inventor: Sean Peter Clarke, Oxfordshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/138,026

(22) Filed: Jun. 12, 2008

Related U.S. Application Data
(60) Provisional application No. 60/934,255, filed on Jun. 12, 2007.

(51) Int. Cl. A45D 27/28; B26B 21/40; B26B 21/44

(52) U.S. Cl. 30/535; 30/537; 30/541

(57) ABSTRACT

A shaving razor comprising:
a. a handle having a proximate end and a distal end wherein said handle comprises a cavity;
b. an adapter neck pivotally joined to said proximate end of said handle, wherein said adapter neck further comprises
   1) a pump to which is joined a first feeding channel extending from said cavity, wherein the pump is actuated by pivotal movement of said neck; and
   2) a cartridge connection yoke disposed at an opposite end of said neck from said handle; through which said feeding channel runs; and
c. a razor cartridge comprising a blade wherein said cartridge is joined to said neck by said cartridge connection yoke and wherein said feeding channel continues to run to a disposal point on said cartridge.

### CROSS REFERENCE TO RELATED APPLICATION

This application claims the benefit of U.S. Provisional Application No. 60/934,255, filed Jun. 12, 2007.

### FIELD OF THE INVENTION

This invention relates to an automatic liquid dispensing razor that is actuated by a user's shaving motion.

### BACKGROUND OF THE INVENTION

This invention relates to the field of wet shaving which is the process where a razor with one or more sharpened blades is moved along skin to cut hair. When a consumer engages in the wet shaving experience, it is typical to apply a skin preparation, e.g., shaving soap, shaving cream, shaving gel, skin conditioning foam, etc., via a brush or manual application prior to movement of the razor along the skin's surface. Most consumers find this type of preparation to be rather inconvenient because of the need for multiple shaving products, e.g., a wet shaving razor and a skin preparation product, as well as the undesirable necessity for multiple application steps during the wet shaving process. This multi-step process also results in an overall extended shaving experience which most consumers do not prefer given typical morning hygiene routines. In certain instances, however, it may still be desirable sometimes to apply fluids of other kinds to the skin before, during, or after shaving to promote ancillary skin and/or hair benefits.

In the past, there have been a number of wet shaving product configurations that include a system for conveying a shaving preparation, e.g. a lubricating fluid, from a reservoir incorporated in the razor structure in the form of a hollowed out razor handle or even an aerosol can that acts as a razor handle, to a dispensing location near the head of the razor. A number of more recent wet shaving razors have cartridges that are movably mounted, in particular pivotable, relative to the handle structures on which they are mounted either permanently, in the case of disposable safety razors intended to be discarded when the blade or blades have become dulled, or detachably to allow replacement of the blade unit on a reusable handle structure. An exemplary razor of this sort is disclosed in U.S. Pat. No. 6,789,321 issued to Simms on Sep. 14, 2004 or U.S. Pat. No. 7,127,817 issued to Orloff et al. on Oct. 31, 2006. Many of these types of razors that are capable of conveying a liquid to the skin surface are unfortunately plagued by a number of problems. For instance, the innerworkings of the razors tend to be cost prohibitive from a large scale manufacturing standpoint. Additionally, there are safety and performance issues that are constantly experience due to microbial growth with the reservoir due to the continued exposure of a portion of the remaining liquid to air. This exposure of the liquid to air may oftentimes result in clogging of the razor's innerworkings by the liquid resulting in a nonperforming shaving product.

### SUMMARY OF THE INVENTION

The present invention relates to a shaving razor comprising:
a. a handle having a proximate end and a distal end wherein said handle comprises a cavity;
b. an adapter neck pivotally joined to said proximate end of said handle, wherein said adapter neck further comprises
   1) a pump to which is joined a first feeding channel extending from said cavity, wherein the pump is actuated by pivotal movement of said neck; and
   2) a cartridge connection yoke disposed at an opposite end of said neck from said handle; through which said feeding channel runs; and
c. a razor cartridge comprising a blade wherein said cartridge is joined to said neck by said cartridge connection yoke and wherein said feeding channel continues to run to a disposal point on said cartridge.

In another embodiment, the present invention relates to a shaving implement suited for carrying a replaceable razor cartridge, said razor comprising:
a. a handle having a proximate end and a distal end wherein said handle comprises a cavity;
b. an adapter neck pivotally joined to said proximate end of said handle, wherein said adapter neck further comprises
   1) a pump to which is joined a first feeding channel that extends from said cavity, wherein the pump is actuated by pivotal movement of said neck; and
   2) a cartridge connection yoke disposed at an opposite end of said neck from said handle through which said first feeding channel runs and terminates at a connectable endpoint.

### BRIEF DESCRIPTION OF THE DRAWINGS

FIG. 1 shows a top perspective view of a razor of the present invention.

FIG. 2 shows a bottom perspective view of the cartridge of the razor of FIG. 1.

FIG. 3 shows an exploded perspective view of the razor of FIG. 1.

### DETAILED DESCRIPTION OF THE INVENTION

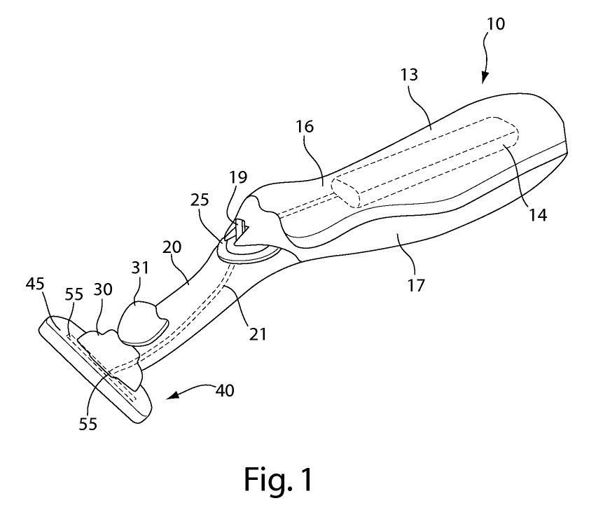

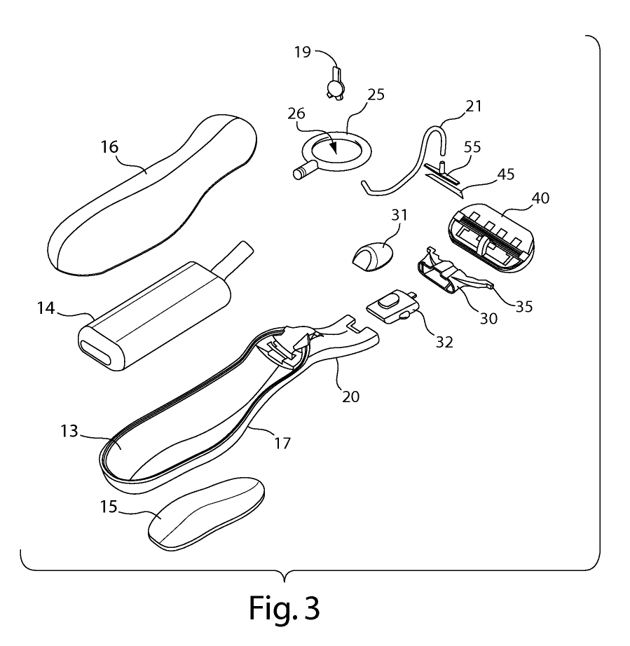

The shaving razor shown in FIGS. 1 and 3 includes a handle 10 that includes a proximal end 11 and a distal end 12 and the handle 10 includes a cavity 13. Attached or joined pivotally to the handle 10 at the proximal end is an adapter neck 20. The adapter neck 20 comprises a pump 25 from which extends a first feeding channel 21 to the cavity 13. The pump is actuated by pivotal action of the neck 20 and moves a liquid from the cavity 13 through the first feeding channel 21. The neck further includes a cartridge connection yoke 30. This yoke 30 is disposed at an opposite end of the neck 20 from the handle 10. The handle 10 may comprise an upper portion 16 and a lower portion 17 that are intended for connectable joiner to form the handle and thereby form the external boundaries of the cavity 13. FIG. 3 additionally shows that the cavity may contain a sachet 14 useful for storing a treatment composition to be dispensed during shaving as well as a gripping element on the handle 10. This gripping element may be placed on the upper portion, lower portion, or both to aid a consumer's grip of the razor during use.

The first feeding channel 21 of FIGS. 1 and 3 runs through the neck 20 and terminates at a disposal point 55 on a razor cartridge 40. The cartridge 40 comprises a blade 45 and is joined to the adapter neck 20 by the cartridge connection yoke 30.

The yoke 30 comprises at least one arm 35 that extends to connect to a razor cartridge 40. By way of an ejector button 31, the yoke 30 may releasably engage the razor cartridge 40 which further includes one or more blades 45. The first feeding channel 21 leads from the pump 25 to a disposal point 55 within the cartridge 40 to allow for disbursement of a fluid to a user's skin during shaving. In a certain embodiment the disposal point 55 is a manifold. The manifold may be capable of delivering the fluid at a single point or multiple, evenly or unevenly distributed points along the length of the one or more blades 45.

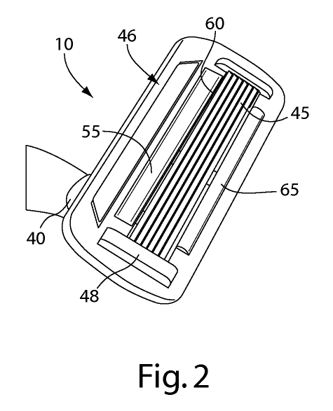

In FIG. 2, the one or more razor blades 45 are sandwiched between a guard 60 and a lubricating strip 65. The guard is useful for stretching the skin's surface immediately prior to engagement with the blade or a first blade (when more than one blade is present). This guard may typically comprise elastomeric material to allow for an engagement that is comfortable to a user. The lubricating strip, on the other hand, provides an additional treatment to the skin after contact between the fluid and the skin has occurred. The lubricating strip may contain the same or additional skin ingredients to those that are present in the fluid. Suitable lubricating strips are disclosed in U.S. Pat. No. 7,069,658 issued to Tseng et al. on Jul. 4, 2006, U.S. Pat. No. 6,944,952 issued on Sep. 20, 2005, U.S. Pat. No. 6,594,904 issued on Jul. 22, 2003, U.S. Pat. No. 6,182,365 issued to Tseng et al. on Feb. 6, 2001, US Design Patent D424745 issued to Tseng et al. on May 9, 2000, and U.S. Pat. No. 6,185,822 issued to Tseng et al. on Feb. 13, 2001, and U.S. Pat. No. 6,298,558 issued to Tseng on Oct. 9, 2001, and U.S. Pat. No. 5,113,585 issued to Rogers et al. on May 19, 1992.

A spreading medium 46 may be placed below, above, or integral to the guard within the razor cartridge. In the embodiment of FIG. 2, the spreading medium is positioned below the blade. The spreading medium may comprise a porous material selected from the group consisting of polyurethane, polyethylene, and combinations thereof. For instance, e.g., a sintered polyethylene material which is commercially available from Porex Technologies GmBH is suited for use herein. This porous material may be either hydrophilic or hydrophobic depending on the polarity of the fluid to be dispensed by the razor. Likewise, the average pore size of the material may range from about 1 micron to about 500 microns, from about 5 microns to about 300 microns, from about 5 microns to about 200 microns, from about 10 microns to about 150 microns, from about 10 microns to about 100 microns, from about 20 microns to about 60 microns, and from any specific lower limit to any specific upper limit within the broadest range mentioned herein. The spreading medium may be used in any shape or size that snugly fits in the razor cartridge in advance of the blade or blades. Also, in certain embodiments the spreading medium may extend substantially along a full length of the cartridge as shown in FIG. 2. In others, the medium may extend across only a central portion of the cartridge, either above or below the guard and/or blades.

In order to preserve the utility of the spreading medium, it is envisioned that a cover may be supplied prior to sale to the consumer for the medium to prevent inadvertent dehydration of the fluid to be dispensed from the razor. In a certain embodiment, the pump of the razor may be primed to pre-wet the spreading medium with the fluid or treatment composition prior to consumer use. Alternatively, such a cover could also be used by the end user to prevent dehydration of the fluid even after the initial priming of the pump when the shaving razor is used by the user for the first time.

FIG. 2 also shows clips 48 which are useful for retaining and maintaining the stability of the blade before, during, and after use of the razor.

The adapter neck may be either permanently or removably joined to the handle. In the case where the adapter head is removable, the cavity may also be removably accessible or just accessible at the point of joiner between the handle and the neck. In the instance where it is desired that the entire razor be deemed disposable, e.g., suitable for five or fewer uses, the handle and adapter neck may be integrally formed with the cavity being filled with a fluid during manufacture or soon thereafter or at the very least prior to purchase by a user and not being capable of easy refilling by the user.

In a certain embodiment as shown in FIGS. 1 and 3, the pump 25 included in the adapter neck may be a pump that included stacked components and particularly a movable wall 26 that acts to activate the flow of fluid from the cavity through a first feeding channel and to the disposal point. A pump suitable for use in the present invention is disclosed in U.S. Pat. No. 5,993,180 issued to Westerhof on Nov. 30, 1999. In particular, this well-suited pump includes a pump chamber bounded by the movable wall, an inlet channel and an outlet channel, both of which are connected to the pump chamber, an inlet valve for closing the inlet channel, and an outlet valve for closing the outlet channel. The movable wall 26 of the pump may take a number of forms. For instance, one movable wall embodiment may comprise a rigid topside that moves in the z-direction in response to a force acted upon the rigid topside that in turn causes non-rigid side walls of the pump to compress to move a fluid through the razor. In another embodiment, the topside surface of the wall may be flexible such that the mere application of force to the flexible topside results in a “movable” wall that gives in response to such force. In most instances, the pump may be actuated by the defined and restricted (via a limited rotation of a pivotal axis of the neck) movement by a shaver's stroke of the shaving surface. This permits the user to easily control the amount of fluid that is dispensed during the shaving experience. Because the valves of the pump are automatically opened when force is exerted on the wall of the pump of the neck by shaving a skin surface. It is also possible to place one or more movable walls of the pump on an upper surface or lower surface of the razor depending on a the configuration of the shaving product relative to whether the wall of the pump to which force or pressure is applied is on a top side or under side of the adapter neck.

With respect to the handle, it is the intention of the present invention that the razor be actuated and liquid dispensed as a result of the user's shaving motion. As part and parcel of such a user driven capability, the razor may additionally comprise an adjustable flow rate switch 19.

In certain embodiments, the switch 19 may be disposed on an upper portion or lower portion of the handle. Such an adjustable flow rate 19 switch may allow the user to increase or decrease the amount of fluid that is dispensed per shaving motion or stroke based on his/her needs, i.e., hair and/or skin texture. Moreover, this same switch may also serve the function of preventing the pivotal movement of the adapter neck when a force is exerted by a user when a skin surface is shaved. In this instance, there would be no dispensing of a fluid to the skin surface during shaving or at any other time until such a switch is moved from this “closed” to an “open” position. This may be a desirable option when a user has adequately lubricated the skin surface to be shaved and no longer wishes his/her stroke during shaving to dispense any further fluids.

The switch may take various forms, e.g., a two position, flip-type or rotary (dial) switch useful for a “closed” and an “open” position or a three or more position, flip-type or rotary (dial) switch which further includes at least one intermediate “open” position in advance of the full “open” position.

There are a number of fluids that may be useful in the present razor. For instance, shaving gels, shaving foams, shaving lotions, skin treatment compositions, conditioning aids, etc. may be used to prepare the skin's surface prior to the engagement of the blade with the skin. Additionally, such materials may comprise benefit agents suitable for skin and/or hair that may be useful for a number of different desirable effects including exfoliation, cooling effects, cleansing, moisturization, warming or thermogenic effects, conditioning, and the like. Suitable benefit agents for skin and/or hair for inclusion into the fluid of the razor are disclosed in U.S. Pat. No. 6,789,321. For instance, suitable agents include but are not limited to shaving soaps, lubricants, skin conditioners, skin moisturizers, hair softeners, hair conditioners, fragrances, skin cleansers, bacterial or medical lotions, blood coagulants, anti-inflammatories, astrigents, and combinations thereof. In certain embodiments, the fluid may be contained in a sachet, either disposable or reusable, that is further contained within the cavity of the handle. The sachet may comprise one or more walls which may be rigid, semi-rigid, collapsible, or a combination thereof.

The razor cartridge of the present invention may be releasably engaged from the cartridge yoke and such elements are disclosed in U.S. Pat. Nos. D533,684 S, 5,918,369, and 7,168,173 B2. This disengagement of these two components allows for replacement of razor cartridges as the continued use of such cartridges causes blade dulling. Thus, such cartridges are replaceable and disposable at will by the user. The yoke further comprises one or more arms that extend from the yoke and provide pivotal support of the yoke against the cartridge. The yoke may additionally comprise an ejection button to disengage the yoke from the cartridge to allow for simple replacement of the cartridge when blades have been dulled due to wear.

Another embodiment of the present invention merely relates to an implement that may be used in conjunction with a razor cartridge. This implement is suited for carrying a replaceable razor cartridge and comprises a handle having a proximate end and a distal end wherein the handle comprises a cavity; an adapter neck pivotally joined to the proximate end of the handle, wherein the adapter neck further comprises 1) a pump to which is joined a first feeding channel that extends from said cavity, wherein the pump is actuated by pivotal movement of said neck; and 2) a cartridge connection yoke disposed at an opposite end of the neck from the handle through which the first feeding channel runs and terminates at a connectable endpoint.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor comprising:
a. a handle having a proximate end and a distal end wherein said handle comprises a cavity;
b. an adapter neck pivotally joined to said proximate end of said handle, wherein said adapter neck further comprises
1) a pump to which is joined a first feeding channel extending from said cavity, wherein the pump is actuated by pivotal movement of said neck; and
2) a cartridge connection yoke disposed at an opposite end of said neck from said handle; through which said feeding channel runs; and
c. a razor cartridge comprising a blade wherein said cartridge is joined to said neck by said cartridge connection yoke and wherein said feeding channel continues to run to a disposal point on said cartridge.

2. The shaving razor of claim 1 wherein the handle comprises an upper and a lower portion that fit together to form the handle.

3. The shaving razor of claim 1 wherein the cavity is suited to accommodate a sachet of a treatment composition.

4. The shaving razor of claim 1 wherein the pump comprises a movable wall upon which force is acted upon to move a treatment composition through the feeding channel to the disposal point.

5. The shaving razor of claim 4 wherein said force is exerted on the wall of the pump of the neck by shaving a skin surface.

6. The shaving razor of claim 5 wherein the treatment composition is dispensed in response to the disposal point in response to a shaving motion.

7. The shaving razor of claim 1 wherein the pump comprises a rigid wall upon which force is acted upon to cause the movement of non-rigid sidewalls of said pump to move a treatment composition through the feeding channel to the disposal point.

8. The shaving razor of claim 1 wherein said razor cartridge is replaceable.

9. The shaving razor of claim 1 wherein said handle comprises an adjustable flow rate switch.

10. The shaving razor of claim 9 wherein said adjustable flow rate switch is disposed on said handle in a location selected from the group consisting of an upper portion of said handle or a lower portion of said handle.

11. The shaving razor of claim 9 wherein said adjustable flow rate switch prevents pivotal movement of the neck when a force is exerted by shaving a skin surface.

12. The shaving razor of claim 1 wherein a skin treatment composition is fed from a sachet within said cavity through said feeding channel to said disposal point.

13. The shaving razor of claim 12 wherein said disposal point runs along a length of said blade.

14. The shaving razor of claim 12 wherein said treatment composition comprises a benefit agent suitable for skin and/or hair.

15. The shaving razor of claim 1 wherein said cartridge further comprises a lubrication strip.

16. The shaving razor of claim 1 wherein said cartridge further comprises a guard.

17. The shaving razor of claim 1 wherein said cartridge further comprises a spreading medium.

18. The shaving razor of claim 17 wherein said spreading medium is primed with a treatment composition prior to consumer use.

19. The shaving razor of claim 18 wherein said spreading medium is paired with a cover to be removed by a consumer.

20. The shaving razor of claim 1 wherein said cartridge connection yoke comprises an ejection button for releasably engaging said cartridge.

21. The shaving razor of claim 1 wherein said razor further comprises a secondary dispensing button.

22. A shaving implement suited for carrying a replaceable razor cartridge, said implement comprising:
a. a handle having a proximate end and a distal end wherein said handle comprises a cavity;
b. an adapter neck pivotally joined to said proximate end of said handle, wherein said adapter neck further comprises
1) a pump to which is joined a first feeding channel that extends from said cavity, wherein the pump is actuated by pivotal movement of said neck; and
2) a cartridge connection yoke disposed at an opposite end of said neck from said handle through which said first feeding channel runs and terminates at a connectable endpoint.

23. The shaving implement of claim 22 wherein the handle comprises an upper and a lower portion that fit together to form the handle.

24. The shaving implement of claim 22 wherein the cavity is suited to accommodate a sachet of a treatment composition.

25. The shaving implement of claim 24 wherein said pump, first feeding channel, and sachet form an integral assembly which is replaceable.

26. The shaving implement of claim 22 wherein the pump comprises a movable wall upon which force is acted upon to move a skin treatment composition through the first feeding channel to a disposal point on a razor cartridge that is joined to the cartridge connection yoke.

27. The shaving implement of claim 26 wherein said force is exerted by shaving a skin surface.

28. The shaving implement of claim 22 wherein said handle comprises an adjustable flow rate switch.

29. The shaving implement of claim 28 wherein said adjustable flow rate switch is disposed on said handle in a location selected from the group consisting of an upper portion of said handle or a lower portion of said handle.

30. The shaving implement of claim 29 wherein said adjustable flow rate switch prevents pivotal movement of the neck when a force is exerted by shaving a skin surface.

31. A kit comprising:
a. the shaving implement of claim 22 and
b. a razor cartridge comprising a blade and a second feeding channel that runs to a disposal point along said blade
and wherein said first feeding channel is connectable to said second feeding channel.
